(19) United States
(12) Patent Application Publication
(10) Pub. No.: US 2014/0021314 A1
(43) Pub. Date: Jan. 23, 2014

(54) ACCESSORY SUPPORT RING FOR AN OUTDOOR COOKING VESSEL

(71) Applicant: Matthew Bourlier, St. Clair Shores, MI (US)

(72) Inventor: Matthew Bourlier, St. Clair Shores, MI (US)

(21) Appl. No.: 13/555,426

(22) Filed: Jul. 23, 2012

(51) Int. Cl. A47J 36/00

(52) U.S. Cl. 248/225.11

(57) ABSTRACT

An accessory support ring for use with a cooking vessel having an interior chamber at least partially defined by a hollow base and a lid mateable with an open distal portion of the hollow base is described. The support ring is positionable for engagement between the hollow base and the lid to create a gap between the open distal portion of the hollow base and the lid. Further, the support ring extends between the open distal portion of the hollow base and the lid through the gap to substantially close the gap and to at least partially define the interior chamber contiguously with the hollow base and the lid. The support ring also defines at least one recess for receiving a portion of an accessory configured to extend from the interior chamber of the cooking vessel to a space exterior to the cooking vessel through the gap.

### BACKGROUND

Hollow cooking vessels, including without limitation kamado style outdoor cooking vessels, are used for recreational and commercial cooking purposes. Such cooking vessels are generally configured to contain heat usable for cooking food items placed within an interior chamber of the cooking vessel.

Accessories can be utilized in combination with these cooking vessels to enhance their usefulness. However, when these accessories include portions that are designed to extend from the interior chamber of a cooking vessel into a space exterior to the cooking vessel, interference can be created between the constituent parts of the cooking vessel and the accessory. This interference can be undesirable with respect to the operation and/or structure of the cooking vessel, the accessory, or both.

### SUMMARY

Disclosed herein is an embodiment of an accessory support ring. In one aspect, the accessory support ring is for use with a cooking vessel having an interior chamber at least partially defined by a hollow base and a lid mateable with an open distal portion of the hollow base. The support ring is positionable for engagement between the hollow base and the lid to create a gap between the open distal portion of the hollow base and the lid. Further, the support ring extends between the open distal portion of the hollow base and the lid through the gap to substantially close the gap and to at least partially define the interior chamber contiguously with the hollow base and the lid. The support ring also defines at least one recess for receiving a portion of an accessory configured to extend from the interior chamber of the cooking vessel to a space exterior to the cooking vessel through the gap.

In another aspect, the accessory support ring is for use with a cooking vessel having an interior chamber at least partially defined by a hollow base and a lid mateable with an open distal portion of the hollow base. The support ring has an annular profile and including a first surface opposing a second surface, and is configured for operative positioning between the hollow base and the lid wherein the first surface rests on the open distal portion of the hollow base and the second surface supports the lid adjacent the open distal portion of the hollow base such that a gap is created between the open distal portion of the hollow base and the lid. The support ring is sized such that a radially inner side wall extending between the first surface and the second surface at least partially defines the interior chamber when the support ring is operatively positioned between the hollow base and the lid. The support ring also defines a recess extending from the radially inner portion to a radially outer side wall to provide clearance for a portion of an accessory extending through the gap from the interior chamber of the cooking vessel to a space exterior to the cooking vessel.

These and other aspects will be described in additional detail below.

### BRIEF DESCRIPTION OF THE DRAWINGS

The various features, advantages and other uses of the present apparatus will become more apparent by referring to the following detailed description and drawing in which:

FIG. 1 is a perspective view of a cooking vessel illustrating a lid oriented in an open position with respect to a base portion;

FIG. 2 is a perspective view of the cooking vessel illustrating the lid oriented in a closed position with respect to the base portion;

FIG. 3 is a perspective assembly view of the cooking vessel illustrating an accessory for use in combination with the outdoor cooking vessel and further illustrating an exemplary accessory support ring;

FIG. 4 is a perspective view of the cooking vessel illustrating the accessory and the accessory support ring operatively disposed between the base portion and the lid while the lid is oriented in the closed position with respect to the base portion;

FIG. 5 is a perspective view illustrating the construction of the accessory support ring; and

FIG. 6 is a side plan view of the accessory support ring.

### DETAILED DESCRIPTION

The exemplary embodiment of the accessory support ring described herein is configured for complimentary use with an accessory for a cooking vessel. The accessory support ring includes features for creating clearance for portions of the accessory that extend from an interior chamber of the cooking vessel into a space exterior to the cooking vessel, such that interference is prevented between the accessory and the constituent parts of the cooking vessel. The accessory support ring further includes features for suitably maintaining the functionality of the cooking vessel when the accessory support ring is used in combination with the cooking vessel and the accessory.

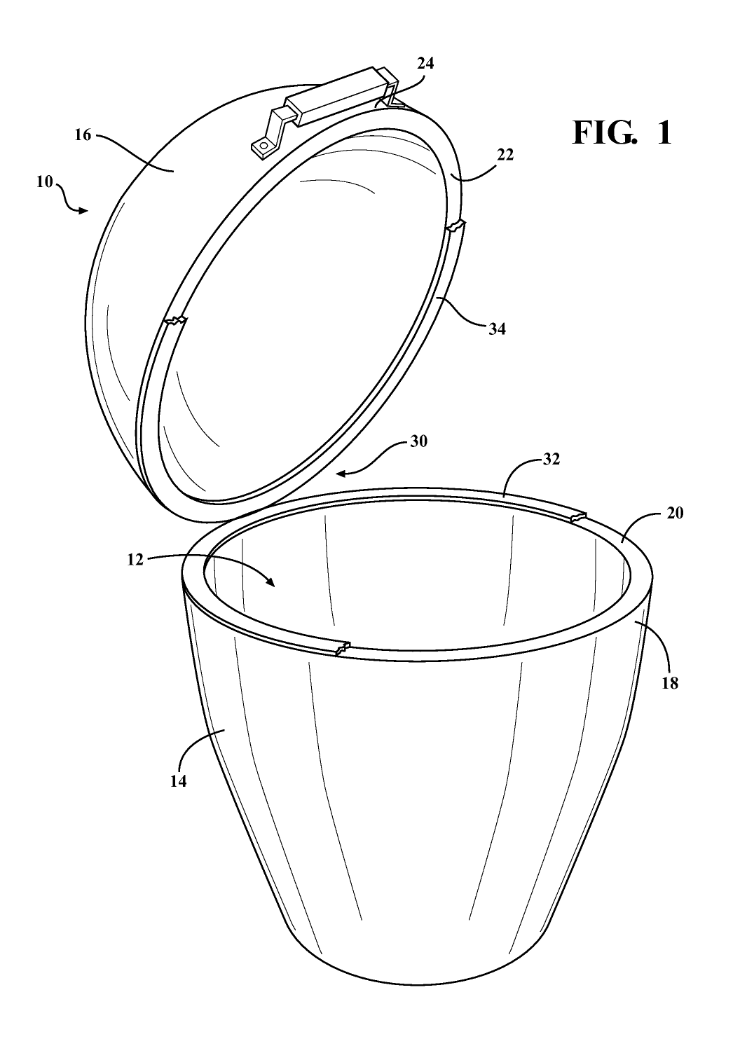

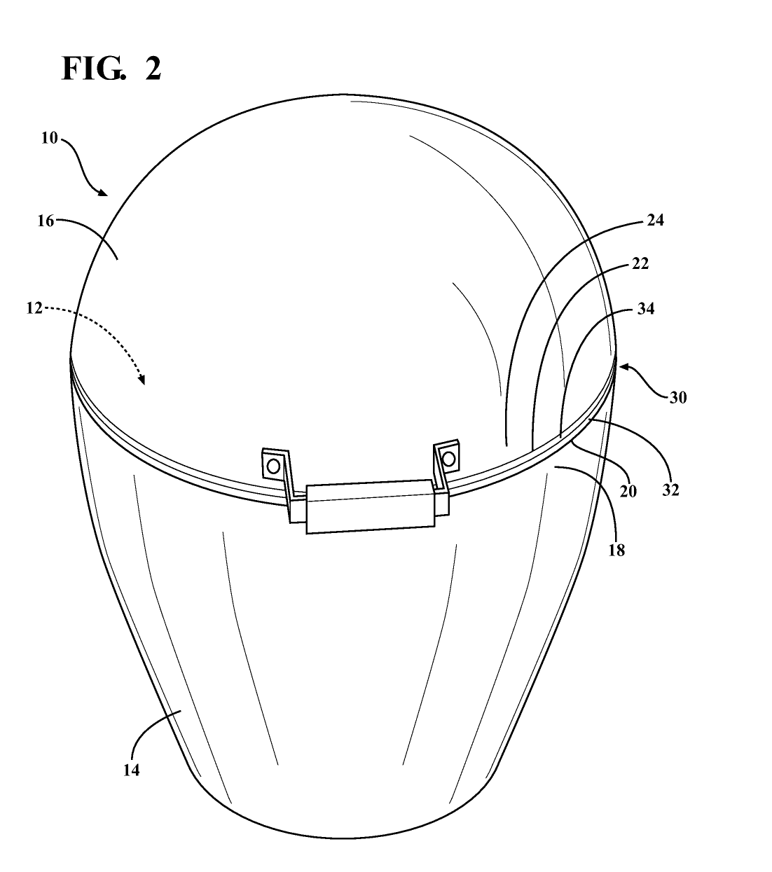

An exemplary cooking vessel 10 is illustrated in FIGS. 1 and 2. The cooking vessel 10 could be a barbeque or a grill, for example, but can be any cooking vessel known to those skilled in the art. In the illustrated implementation, the cooking vessel 10 is a kamodo style cooking vessel similar in configuration to the device described in U.S. Pat. No. 7,644,711, the disclosure of which is incorporated herein in its entirety.

The cooking vessel 10 is hollow to generally define an interior chamber 12. The cooking vessel 10 is configured to contain a heat within the interior chamber 12 usable for cooking food items placed therein. The cooking vessel 10 could be composed of a ceramic material, for example, although other suitable materials known to those skilled in the art could also be used.

The illustrated cooking vessel 10 has a base 14 and a lid 16. The base 14 and the lid 16 are combinable to at least partially define the interior chamber 12. As shown, the base 14 is generally hollow, and the lid 16 is mateable to an open distal portion 18 of the base 14, such that the open distal portion 18 is closed and the interior chamber 12 is generally defined by the base 14 and the lid 16.

The open distal portion 18 of the base 14 may include a lip 20 configured for supporting the lid 16 with respect to the base 14. As shown, the lip 20 of the base 14 is formed at a terminating edge of the open distal portion 18 of the base 14. The illustrated lid 16, similar to the base 14, is also generally hollow and includes a lip 22 corresponding to the lip 20 of the base 16 formed at a terminating edge of an open distal portion 24 of the lid 16. The lip 22 of the lid 16 is configured for mateable engagement with the corresponding lip 20 of the base 14. The base 14 and the lid 16 are each generally domical, with respective lips 20 and 22 having generally circular annular cross sections. The lip 20 of the base 14 and the lip 22 of the base 16 are both shown as generally planar structures.

The cooking vessel 10 is illustrated in FIG. 1 with the lid 16 pivotally rotated with respect to the base 14 to an open position to expose the interior chamber 12. The lid 16 is illustrated as pivotally coupled to the base 14 through a hinge mechanism , although the lid 16 could be otherwise coupled to the base 14, or could be uncoupled to the base 14. As shown in FIG. 2, the lid 16 is invertedly positionable with respect to the base 14, and is configured to rest upon the open distal portion 18 of the base 14 such that the lip 22 of the lid 16 mateably engages the lip 20 of the base 14, such that the base 14 and the lid 16 substantially form the generally ovoid hollow cooking vessel 10.

The illustrated cooking vessel 10 may include a heat seal 30 provided to help prevent heat contained within the interior chamber 12 from escaping from between the base 14 and the lid 16. As shown, the heat seal 30 is positionable between the open distal portion 18 of the base 14 and the open distal portion 24 of the lid 16. The heat seal 30 can generally include one or more components for application to at least one of the open distal portion 18 of the base 14 and the open distal portion 24 of the lid 16. For example, the illustrated heat seal 30 may include a pair of heat sealing strips 32 and 34, with the heat sealing strip 32 applied to the lip 20 of the open distal portion 18 of the base 14, and the heat sealing strip 34 applied to the lip 22 of the open distal portion 24 of the lid 16. The heat sealing strips 32 and 34 are generally compliant to compress against each other when the lip 22 of the lid 16 is disposed in mateable engagement with the lip 20 of the base 14. It will be understood that the heat seal 30 can generally be disposed between the open distal portion 18 of the base 14 and the lid 16. The terms mateable, mateable engagement and the like used in the description of the spatial relationships between the constituent structures of the base 14 and the lid 16 should be understood thusly.

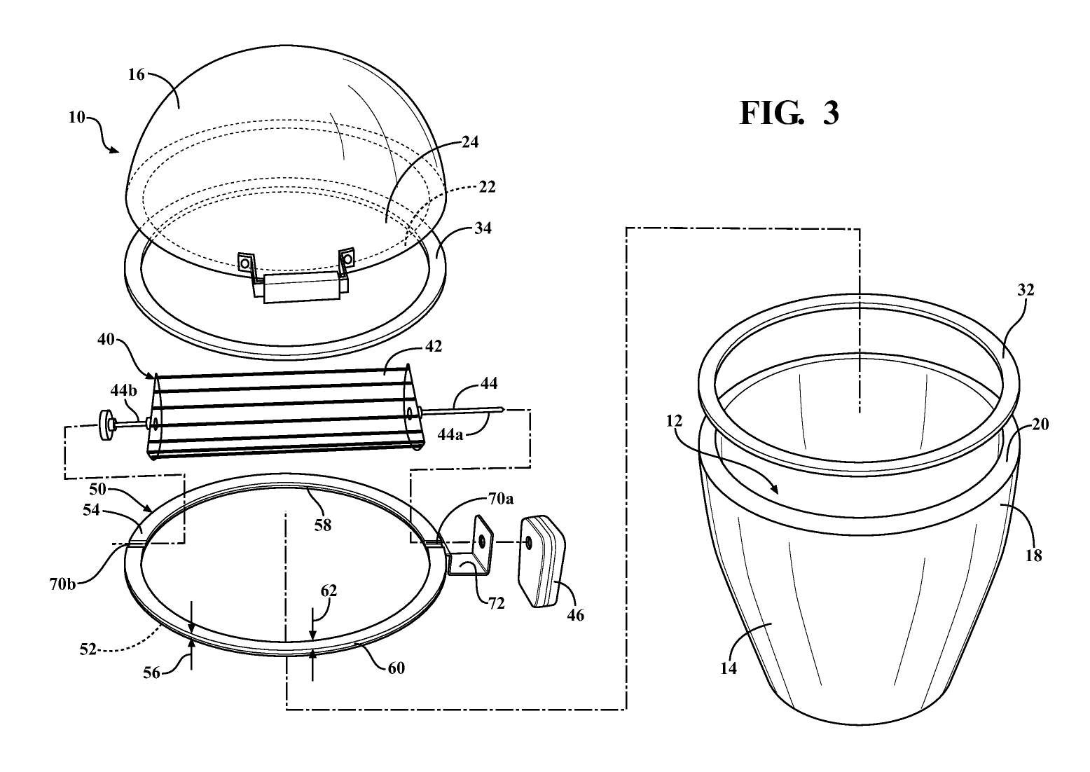

FIG. 3 is an assembly view showing the cooking vessel 10, including the base 14, the lid 16 and the heat sealing strips 32 and 34 of the heat seal 30. As shown in FIG. 3, one or more accessories can be used in combination with the cooking vessel 10. For example, a rotisserie 40 is presented as an exemplary accessory for the purpose of illustration and explanation, however, any accessory or other tool that is usable with a cooking vessel could alternatively be used consistently with this disclosure.

An accessory may include portions designed for operational disposition within the interior chamber 12 of the cooking vessel 10. The illustrated rotisserie 40, for example, includes a rack 42 for supporting food items within the interior chamber 12 for cooking. However, some accessories generally will not be entirely containable within the interior chamber 12. For example, an accessory may not be entirely physically containable within the interior chamber 12 when the accessory is operationally oriented, or, it may not be operationally feasible to contain an accessory entirely within the interior chamber 12. In these cases, one or more portions of the accessory will generally extend from the interior chamber 12 of the cooking vessel 10 into a space exterior to the cooking vessel 10.

When such an accessory is used in combination with the cooking vessel 10, interference can be caused between constituent parts of the cooking vessel 10 and the one or more portions of the accessory that extend to the space exterior to the cooking vessel 10. This interference can be undesirable with respect to the operation and/or structure of the cooking vessel 10, the accessory, or both, particularly if such portions of the accessory exhibit motion relative to the cooking vessel 10.

With respect to the illustrated rotisserie 40, for instance, a rotation shaft 44 is connected to the rack 42 and is configured to extend from the interior chamber 12 of the cooking vessel 10 past the lip 20 of the base 14 and the corresponding lip 22 of the lid 16 to position free distal ends 44a and 44b of the rotation shaft 44 in a space exterior to the cooking vessel 10. The free distal end 44a of the rotation shaft 44 can be operated to rotate the rack 42 while that rack 42 is disposed within the interior chamber 12 of the cooking vessel 10 even when the lid 16 is positioned over the base 16. As shown, the free distal end 44a of the rotation shaft 44 is operated by a controller 46, although the free distal end 44a could also be manually operated. However, if the lid 16 is positioned directly over the base 14 of the illustrated cooking vessel 10, portions of the rotation shaft 44 can interfere with the base 14, the lid 16, and/or the heat sealing strips 32 and 34 disposed between the base 14 and the lid 16. This interference can disrupt proper functioning of the heat seal 30. Further, as the rotation shaft 44 rotates, the relative motion between the rotating rotation shaft 44 and the stationary heat sealing strips 32 and 34 can cause damage to the heat sealing strips 32 and 34. Even in the absence of the illustrated heat sealing strips 32 and 34, relative motion between the rotating rotation shaft 44 and the lip 20 of the base 14 and the lip 22 of the lid 16 can cause the rotation shaft 44 to travel with respect to the lips 20 and 22, which can disrupt the proper functioning of the rotisserie 40 and cause damage to the rotisserie 40 and the lips 20 and 22.

As shown in FIG. 3, an exemplary support ring 50 may be positioned between the base 14 and the lid 16 of the cooking vessel 10 to minimize or eliminate undesirable interference between the base 14, the lid 16 and/or the heat seal sealing strips 32 and 34 of the cooking vessel 10 and the portions of the rotisserie 40 that extend from the interior chamber 12 of the cooking vessel 10 into the space exterior to the cooking vessel 10. The support ring 50 according to the present disclosure is also generally useful for implementation with the illustrated cooking vessel 10 and rotisserie 40 for reasons of general convenience and/or aesthetics, for example. Further, support ring 50 may also be employed with other cooking vessels and accessories.

The support ring 50 is generally configured to create a gap between the open distal portion 18 of the base 14 and the lid 16 to provide clearance for the portions of the rotisserie 40 extending from the interior chamber 12 of the cooking vessel 10 to a space exterior to the cooking vessel 10. In its operative position between the open distal portion 18 of the base 14 and the lid 16, the support ring 50 is configured to rest on the open distal portion 18 of the base 14 and to support the lid 16 in a spaced relation from the open distal portion 18 of the base 14.

The support ring 50 is configured for engagement between the open distal portion 18 of the base 14 and the lid 16 of the cooking vessel 10. Specifically, the illustrated support ring 50 has a lower first surface 52 configured to rest on the open distal portion 18 of the base 14 and an upper second surface 54 opposing the first lower surface 52 configured to support the lid 16. The support ring 50 has a thickness 56 between the lower first surface 52 and the upper second surface 54. The specific thickness 56 of the support ring 50 can be determined such that the support ring 50 creates a gap between the open distal portion 18 of the base 14 and the lid 16 suitable for providing clearance for the portion(s) of an accessory extending through the gap from the interior chamber 12 of the cooking vessel 10 to the space exterior to the cooking vessel 10.

As described above, the base 14 of the illustrated cooking vessel 10 may include a generally planar lip 20 for supporting the lip 22 of the lid 16. The support ring 50 correspondingly includes the generally planar lower first surface 52 configured to rest in mateable engagement with the lip 20 of the open distal portion 18 of the base 14. Similarly, the support ring 50 includes the generally planar upper second surface 54 configured to support a corresponding planar lip 22 of the lid 16. However, the geometry of the support ring 50 could vary from the particular geometry described above according to corresponding variations in the configuration of the cooking vessel 10. It will also be understood that the lower first surface 52 of the support ring 50 can rest in mateable engagement with the lip 20 of the open distal portion 18 of the base 14 with the heat sealing strip 32 disposed between the lower first surface 52 and the lip 20. Likewise, the upper second surface 54 of the support ring 50 can support the lip 22 of the lid 16 in mateable relation with the heat sealing strip 34 disposed between the upper second surface 54 and the lip 22.

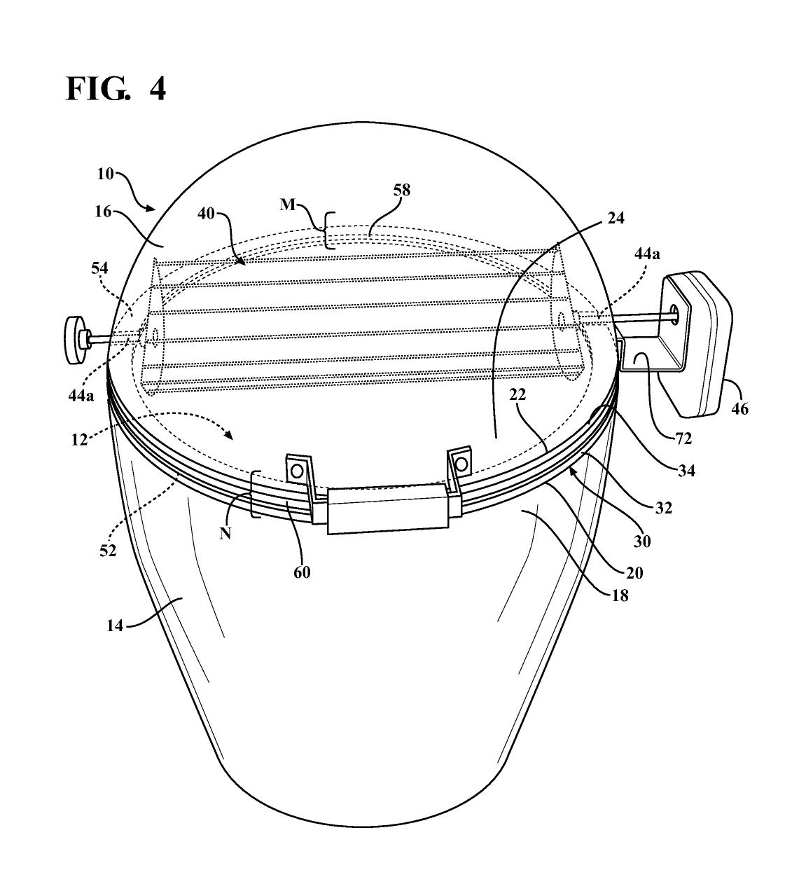

In addition to creating the gap, the support ring 50 is configured to substantially close the gap between the open distal portion 18 of the base 14 and the lid 16 so that the heat containing properties of the inner chamber 12 of the cooking vessel 10 are not compromised when the support ring 50 is disposed between the open distal portion 18 of the base 14 and the lid 16. With additional reference to FIG. 4, the support ring 50 generally extends between the open distal portion 18 of the base 14 and the lid 16 through the gap to at least partially define the interior chamber 12 of the cooking vessel 10 contiguously with the base 14 and the lid 16, as shown at a representative portion M of the interior chamber 12.

The geometry of a support ring will generally correspond to the configuration of a particular cooking vessel for which the support ring is employed. The support ring 50 has the planar lower first surface 52 configured to rest in mateable engagement with the planar lip 20 of the open distal portion 18 of the base 14. Similarly, the support ring 50 has the planar upper second surface 54 configured to support the corresponding planar lip 22 of the lid 16. Additionally, the support ring 50 is itself substantially planar to close a generally planar gap created when the lid 16 is spaced apart from the open distal portion 18 of the base 14, with the lower first surface 52 and the opposing upper second surface 54 generally extending in respective parallel planes transverse to the support ring 50.

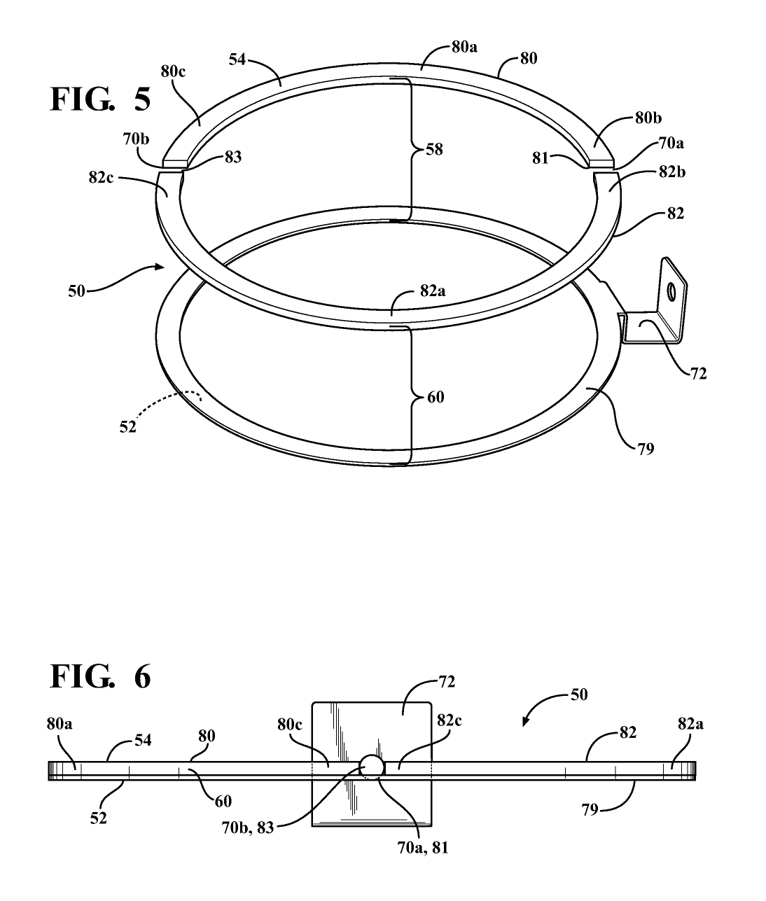

With reference also to FIG. 5, the support ring 50 can form a continuous loop to substantially close a continuous gap between the open distal portion 18 of the base 14 and the lid 16. The support ring 50 has a profile approximating the cross section of the cooking vessel 10 along an interface between the base 14 and the lid 16. The exemplary cooking vessel 10 is generally ovoid in configuration, with the base 14 and the lid 16 each having respective lips 20 and 22 with generally circular annular cross sections. The support ring 50 correspondingly has a generally circular annular profile, with a radially inner surface 58 and a radially outer surface 60. The radially inner surface 58 is a radially inner side wall extending from the lower first surface 52 to the upper second surface 54, and the radially outer surface 60 is a radially outer side wall extending from the lower first surface 52 to the upper second surface 54. The support ring 50 can have a width 62 between the radially inner surface 58 and the radially outer surface 60 that can, for example, correspond to a width of the lip 20 of the open distal portion 18 of the base 14 and/or the lip 22 of the lid 16. When the support ring 50 is disposed between the open distal portion 18 of the base 14 and the lid 16, the radially inner surface 58 may at least partially define the interior chamber 12 of the cooking vessel 10, as shown at the representative portion M of the interior chamber 12, and the radially outer surface 60 may form a portion of the exterior of the cooking vessel 10, as shown at a representative exterior portion N.

As indicated above, the support ring 50 can include features for providing clearance for the portions of the rotisserie 40 extending from the interior chamber 12 of the cooking vessel 10 to a space exterior to the cooking vessel 10. The illustrated support ring 50 defines a pair of recesses 70a and 70b extending through the loop formed by the support ring 50, from the radially inner surface 58 to the radially outer surface 60. The recesses 70a and 70b of the support ring 50 receive the distal ends 44a and 44b of the rotation shaft 44, respectively, to support the rotisserie 40 with respect to the cooking vessel 10. Additionally, the recesses 70a and 70b provide clearance for the distal ends 44a and 44b of the rotation shaft 44 to generally isolate them from contact with the cooking vessel 10. Specifically, the recesses 70a and 70b isolate the distal ends 44a and 44b of the rotation shaft 44 from contact with the base 14, the lid 16, and/or the heat sealing strips 32 and 34 disposed between the base 14 and the lid 16.

The support ring 50 includes the pair of recesses 70a and 70b that are opposedly disposed on the support ring 50 and generally longitudinally aligned in a common plane transverse to the support ring 50. However, the number, placement and orientation of recesses could vary according to corresponding variations in the configurations of the cooking vessel 10, the support ring 50 and/or the accessory for which the support ring 50 is designed.

The support ring 50 may further include features for supporting other portions of an accessory. The support ring 50, for example, may include a bracket 72 for supporting the controller 46 of the rotisserie 40.

An exemplary construction for support ring 50 is described with reference to FIGS. 5 and 6. The support ring 50 can generally be composed of one or more durable materials suitable to withstand the heat contained within the interior chamber 12 of the cooking vessel 10. While the support ring 50 can be a singular component, the illustrated support ring 50 may be composed of multiple components. Specifically, the support ring 50 may include an annular sheet metal base ring 79 configured to support one or more metal upper members 80 and 82. The upper members 80 and 82 can be attached to the base ring 79 using various attachment mechanisms, such as welding, brazing, adhering or fastening, for example.

The illustrated upper members are each generally semi-circular and have profiles that geometrically overlap the profile of the annular base ring 79. The upper member 80 includes a semi-circular center portion 80a formed between distal ends 80b and 80c. Similarly, the upper member 82 includes a semi-circular center portion 82a formed between distal ends 82b and 82c. The upper members 80 and 82 are disposable on the base ring 79 such that spaces 81 and 83 are formed between the distal end 80b of the upper member 80 and the distal end 82b of the upper member 82, and between the distal end 80c of the upper member 80 and the distal end 82c of the upper member 80c, respectively. These spaces are configured to define the recesses 70a and 70b, respectively, for providing clearance for the distal ends 44a and 44b of the rotation shaft 44 of the rotisserie 40, as explained above.

As shown in FIG. 6, where the distal end 80b of the upper member 80 and the distal end 82b of the upper member 82 are generally planar, the resulting recess 70a has a polygonal profile. Similarly, where the distal end 80c of the upper member 80 and the distal end 82c of the upper member 82 are generally planar, the resulting recess 70b has a polygonal profile. However, the upper members 80 and 82 could be configured otherwise such that the recesses 70a and 70b have arcuate profiles, for example.

Where the base ring 79 is fashioned from sheet metal, the economy of its manufacture may be increased by forming the base ring 79 from multiple partially-circular portions, and the bracket 72 can be formed integrally with one or more of these portions. Such portions can be attached using any of a variety of attachment mechanisms, such as welding, brazing, adhering or fastening, for example.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An accessory support ring for use with a cooking vessel having an interior chamber at least partially defined by a hollow base and a lid mateable with an open distal portion of the hollow base, comprising:
the support ring positionable for engagement between the hollow base and the lid to create a gap between the open distal portion of the hollow base and the lid;
the support ring extending between the open distal portion of the hollow base and the lid through the gap to substantially close the gap and to at least partially define the interior chamber contiguously with the hollow base and the lid;
the support ring defining at least one recess for receiving a portion of an accessory configured to extend from the interior chamber of the cooking vessel to a space exterior to the cooking vessel through the gap.

2. The accessory support ring of claim 1, further comprising:
the support ring forming a hollow loop to substantially close the gap and to at least partially define the interior chamber.

3. The accessory support ring of claim 2, further comprising:
the hollow loop having a profile approximating a cross section of the cooking vessel at an interface between the hollow base and the lid.

4. The accessory support ring of claim 3, further comprising:
the hollow loop having a radially inner surface to at least partially define the interior chamber.

5. The accessory support ring of claim 4, further comprising:
the at least one recess extending from the radially inner surface to a radially outer surface of the hollow loop.

6. The accessory support ring of claim 1, wherein the at least one recess is configured to support the portion of the accessory with respect to the cooking vessel and to isolate the portion of the accessory from contact with the cooking vessel.

7. The accessory support ring of claim 1, further comprising:
the support ring defining a plurality of recesses, each for receiving a respective one of a plurality of portions of the accessory configured to extend from the interior chamber of the cooking vessel to a space exterior to the cooking vessel through the gap.

8. The accessory support ring of claim 7, wherein two to the plurality of recesses longitudinally aligned and opposedly disposed about the support ring.

9. An accessory support ring for use with a cooking vessel having an interior chamber at least partially defined by a hollow base and a lid mateable with an open distal portion of the hollow base, comprising:
the support ring having an annular profile and including a first surface opposing a second surface;
the support ring configured for operative positioning between the hollow base and the lid wherein the first surface rests on the open distal portion of the hollow base and the second surface supports the lid adjacent the open distal portion of the hollow base such that a gap is created between the open distal portion of the hollow base and the lid;
the support ring sized such that a radially inner side wall extending between the first surface and the second surface at least partially defines the interior chamber when the support ring is operatively positioned between the hollow base and the lid; and
the support ring defining a recess extending from the radially inner portion to a radially outer side wall to provide clearance for a portion of an accessory extending through the gap from the interior chamber of the cooking vessel to a space exterior to the cooking vessel.

10. The accessory support ring of claim 9, further comprising:
the annular profile approximating a cross section of the cooking vessel at an interface between the hollow base and the lid.

11. The accessory support ring of claim 9, further comprising:
the first surface configured for mating engagement with the open distal portion of the hollow base; and
the second surface configured for mating engagement with the lid.

12. The accessory support ring of claim 9, further comprising:
the first surface and the second surface extending in respective parallel planes transverse to the support ring.

13. The accessory support ring of claim 9, wherein the at least one recess is configured to support the portion of the accessory with respect to the cooking vessel and to isolate the portion of the accessory from contact with the cooking vessel.

14. The accessory support ring of claim 9, further comprising:
the support ring defining a plurality of recesses, each for receiving a respective one of a plurality of portions of the accessory configured to extend from the interior chamber of the cooking vessel to a space exterior to the cooking vessel through the gap.

15. The accessory support ring of claim 14, further comprising:
the support ring composed of a base ring and a plurality of upper members disposed on the base ring, wherein:
the base ring has the annular profile, each of the plurality of upper members has a profile geometrically overlapping the annular profile of the base ring;
the plurality of upper members are disposed on the base ring in a spaced apart arrangement such that the each of the plurality of recesses is defined between respective distal ends of adjacent upper members.
